(19) United States
(12) Patent Application Publication
(10) Pub. No.: US 2019/0332402 A1
(43) Pub. Date: Oct. 31, 2019

(54) ANNOTATED RESPONSES TO LEARN AND GENERATE API SIMULATORS

(71) Applicant: HEWLETT-PACKARD DEVELOPMENT COMPANY, L.P., Houston, TX (US)

(72) Inventor: Justin York, Houston, TX (US)

(21) Appl. No.: 15/966,339

(22) Filed: Apr. 30, 2018

(51) Int. Cl. G06F 9/455; G06N 99/00; G06F 9/54

(52) U.S. Cl. CPC G06F 9/455; G06F 9/542; G06N 99/005

(57) ABSTRACT

In example implementations, an apparatus is provided. The apparatus includes a communication interface, a processor, and a learning device. The communication interface communicates with an application programming interface (API) via annotated responses. The processor is in communication with the communication interface and receives the annotated response. The learning device is in communication with the processor and analyzes the annotated responses, learn a behavior of the API, and generate a simulator for the API.

### BACKGROUND

Hardware devices run software to perform or execute different tasks. In some instances, the hardware devices may be configured to interact, or communicate, with one another.

The hardware devices may execute an application programming interface (API). The API may provide a way for the hardware devices to communicate with one another. The API may be different for different hardware devices. In addition, the API may be different for different software versions being executed by the hardware devices.

### BRIEF DESCRIPTION OF THE DRAWINGS

FIG. 1 is a block diagram of an example system including a hardware device to be programmed and an API simulator of the present disclosure;

FIG. 2 is a block diagram of the hardware device to be programmed of the present disclosure;

FIG. 3 is a flow chart of an example method for automatically generating an API simulator based on an API behavior that is learned based on annotated responses observed during an API simulation; and

FIG. 4 is a block diagram of an example non-transitory computer readable storage medium storing instructions executed by a processor.

### DETAILED DESCRIPTION

Examples described herein provide an apparatus and method for automatically learning an API behavior based on annotated responses observed during an API simulation. As discussed above, hardware devices may execute an application programming interface (API). The API may provide a way for the hardware devices to communicate with one another. The API may be different for different hardware devices. In addition, the API may be different for different software versions being executed by the hardware devices.

Currently, an instance of hardware running the API is used and a programmer manually codes a simulation for the API. Having multiple instances of the hardware can be very expensive. In addition, manually coding the simulator for the API can be a laborious and time consuming process. In addition, manually coding the simulation can lead to errors. The errors may then cause the hardware device to operate improperly or respond incorrectly.

Moreover, the versions of the API on the second device may constantly change or improve. Thus, the programmer may have to constantly change or modify the simulation for the API for the hardware device being programmed. This can be an inefficient process.

Furthermore, manually coding the API can lead to a simulation that uses a generic version of the schema. For example, the manually coding may fix a value of a parameter for all responses when the value should only be sent for simulation of a specific scenario.

Examples of the present disclosure provide a learning device that can learn the behavior for an API based on annotated responses used in the observed communications of the API. The learning device can be implemented on a hardware device that interacts with another device using the API. The responses can be annotated such that the learning device can learn specifics related to the behavior. For example, the annotations may allow the learning device to learn which values are fixed, which values are dynamic, a format for the dynamic fields, when certain values should be provided, and the like.

As a result, the learning device may learn the behavior fora particular API and automatically generate a simulator for the API. The simulator may then be used by other hardware devices to simulate an interaction for that particular API without having to deploy instances of the hardware, which can be very expensive. When the API is updated or new APIs are created, the learning device may automatically learn and generate the simulator for the updated or new APIs.

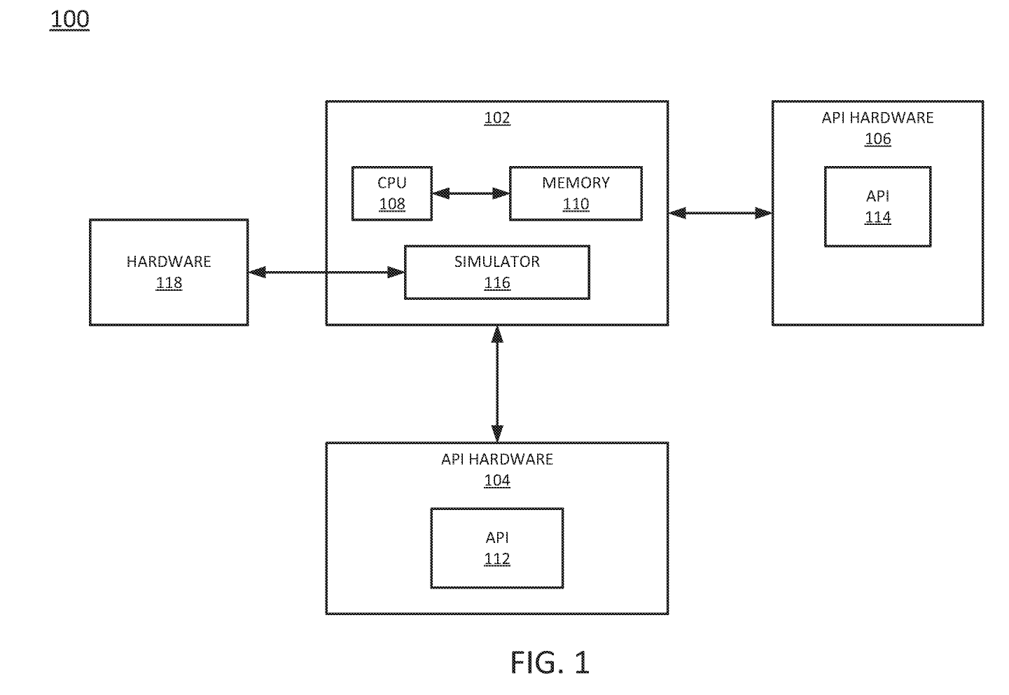

FIG. 1 illustrates an example system 100 of the present disclosure. In one example, the system 100 may include hardware 102 and application programming interface (API) hardware 104 and 106 that execute APIs 112 and 114, respectively. It should be noted that although two hardware implementations 104 and 106 are illustrated in FIG. 1, that any number of API hardware executing any number of APIs may be initially deployed (e.g., one API hardware or more than two API hardware).

In one example, the hardware 102 may be a computing system that is being built to interact with a particular API. For example, the hardware 102 may be being built to interact with an API 112 initially deployed by the API hardware 104 and an API 114 initially deployed by the API hardware 106. Each of the API hardware 104 and 106 may include a processor to execute the respective APIs 112 and 114 stored in memory.

In one example, the hardware 102 may include a central processing unit (CPU) 108 and a memory 110. The CPU 108 may also be referred to as a processor. The memory 110 may include any type of non-transitory computer readable medium, such as, a hard disk drive, a random access memory, a read only memory, and the like. The hardware 102 may include other components that are not shown, such as, an input device, a display, a graphical user interface, network cards, and the like.

In one example, an initial instance of the API hardware 104 and 106 is deployed while the hardware 102 is initially learning a behavior associated with the API 112 and the API 114. In one example, “behavior” of an API may be defined as how the API communicates. For example, the “behavior” may include a pattern of expected responses for particular API calls, how the responses should be formatted, what information is included in the responses, which values can be dynamically changed or remain static, and the like.

As discussed in further detail below, once the behavior of the APIs 112 and 114 are learned, the hardware 102 may replicate the API hardware 104 and 106 in software and generate a simulator 116 of the APIs 112 and 114. The simulator 116 that is generated may then be used to build other hardware devices similar to the hardware 102, or to provide simulations of the APIs 112 and 114 for other hardware devices.

For example, hardware 118 may connect to the simulator 116 to simulate interactions with the API 112 and/or the API 114. Notably, the hardware 118 would not have to purchase and connect to the API hardware 104 or the API hardware 106.

In one example, an API may be defined as a particular language and a format of the language that is used by applications on two different computing device to communicate. The APIs may use a particular behavior where certain parameters may have fixed or dynamic values, where certain API calls provide an API response including certain parameters, and the like. Different programs executed on different computing devices may use different APIs.

In one example, the API calls and the API responses may be annotated such that the hardware 102 may learn the behavior of a particular API. For example, the hardware 102 may observe and analyze annotations in the API calls and API responses of the API 112 to learn the behavior of the API 112. Similarly, the hardware 102 may observer and analyze annotations in the API calls and the API responses of the API 114 to learn the behavior of the API 114.

For example, the API 112 may be an API to query the attributes of a peripheral device in a datacenter server. The API call may be “GET/rest/v1/systems/1/Ethernet/1” and the API response may be a java script object notation (JSON) formatted document, such as:

{
“productName”: “HPE 3820C”,
“serialNumber”: “xy5593”,
“partNumber”: “B21-509311”,
“physicalFunctionCount”: 5,
“portCount”: 2,
“speedGbps”: 20
}

The present disclosure may add annotations to the API response to allow the hardware 102 to learn the behavior of the API for querying the attributes of a peripheral device in a datacenter. For example, the annotated API response may be written as:

{
“productName”: “HPE 3820C”,
“serialNumber”: “xy5593”,
“partNumber”: “B21-509311”,
“physicalFunctionCount”: 5,
“portCount”: 2,
“speedGbps”: 20
}
“dynamicFields””
[
{
“field”: “serialNumber”,
“type”: “string”,
“regex:: “a..z|A..Z{2}0..9{4}”
},
],
“keystoneField”: “productName”
}

The annotations may include information to identify certain fields, such as a dynamic field, a static field, a keystone field, and the like. The dynamic field annotation may identify, or describe, how to synthesize a value for a dynamic field for a particular response. In the above example response, the field “serialNumber” may be identified as a dynamic field. As a result, the hardware 102 may learn that the field “serialNumber” should be different in each response. The annotation may also provide information as to how the field “serialNumber” should be generated. For example, the field is a “string” that includes two randomly generated letters between A-Z and four randomly generated numerical values between 0 and 9.

In one example, the static field annotation may identify, or describe, fields that should be the same for each response. The keystone field annotation may include certain fields when a particular keystone field is included in a response. For example, any response that includes the field “productName” may include the fields “serialNumber”, “partNumber”, physicalFunctionCount”, “portCount”, and “speedGbps”.

The hardware 102 may continue to observer and analyze the annotations of the API calls and the API responses until the behavior of the API 112 or the API 114 is learned. In one example, the behavior may be learned when a pre-defined number of responses are repeated (e.g., five times, 10 times, and the like). For example, the hardware 102 may assume that the behavior is learned when the same API responses are observed.

In another example, the hardware 102 may learn the behavior when all of the API calls and all the API responses are observed. For example, the hardware 102 may notify the API 112 and the API 114 that the hardware 102 is in a learning mode. The API 112 and the API 114 may track which responses have been exchanged until all of the API calls and/or all of the API responses have been exchanged at least one time. When the API 112 and the API 114 determine that all of the API calls and/or API response have been observed, the API 112 and the API 114 may send a notification to the hardware 102 indicating that all of the API responses have been sent and the hardware 102 may exit the learning mode. The hardware 102 may then know that that the simulator 116 of the API 112 and the API 114 is completed in response to the notification.

The hardware 102 may generate a simulator 116 of the API 114 or the API 112 after the behavior is learned. The simulator 116 may be used by other servers or hardware (e.g., the hardware 118) to simulate interaction with the API 112 or 114 without the need to purchase and deploy additional instances of the expensive API hardware 104 and 106.

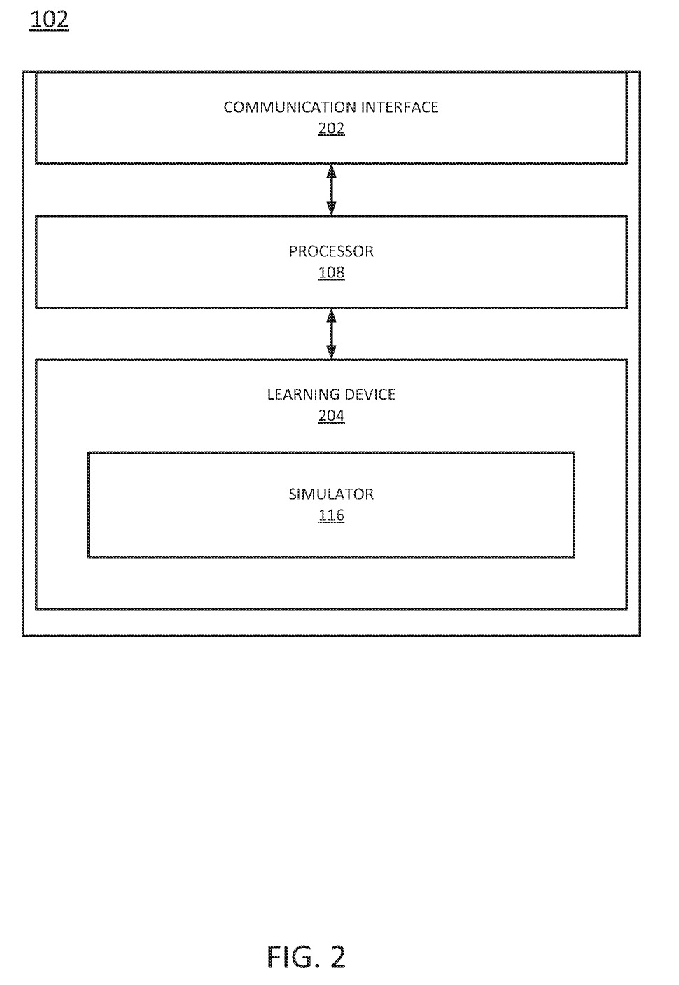

FIG. 2 illustrates a block diagram of the hardware device 102. The hardware device 102 may include the processor 108, a communication interface 202, and a learning device 204. The processor 108 may be communicatively coupled to the communication interface 202 and the learning device 204.

In one example, the communication interface 202 may be to establish a wired or wireless communication path with the API hardware 104 and/or the API hardware 106. For example, the communication interface 202 may be a network interface card with an Ethernet port or a wireless radio.

The communication interface 202 may issue API calls and receive the API responses from the API 112 implemented on the API hardware 104 and/or the API 114 implemented on the API hardware 106 over the wired or wireless communication path. The API responses may be received by the processor 108.

The processor 108 may forward the API responses having the annotations to the learning device 204. The learning device 204 may comprise a set of instructions stored in the memory 110 and executed by the processor 108.

The learning device 204 may analyze the annotations of the API responses to learn the behavior of a particular API. For example, based on the annotations, the learning device 204 may learn which fields may be dynamic, which fields may be static, identify keystone fields, and the like. The learning device 204 may learn a format of the dynamic fields and how to generate the values for the dynamic fields.

When the learning device 204 completes the learning process for the API, the learning device 204 may build a simulator 116. The simulator 116 may be stored in the memory 110. The simulator 116 may be reproduced and be used to replicate the API hardware 104 and/or 106 executing the respective APIs 112 and 114 without the need to deploy the expensive API hardware 104 and 106 used in an initial instance, as discussed above. Moreover, the simulators 116 may be generated more accurately and with fewer errors than if generated manually by a programmer.

In addition, when changes to the API 112 or the API 114 are made (e.g., version updates, changes to the APIs, and the like), the learning device 204 may automatically update the simulator 116. For example, the hardware 102 may be connected to the API hardware 104 or the API hardware 106 to learn the behavior of the changes or updates to the API 112 or the API 114, respectively.

Thus, the annotated API responses may allow the learning device 204 and the hardware 102 to automatically learn the behavior of APIs. The learned behavior may then be used to generate simulators 116 to provide a scalable and automated approach to the creation of API simulators by observation of a real interaction of API calls and API responses, rather than trying to manually program each API call and API response by a programmer.

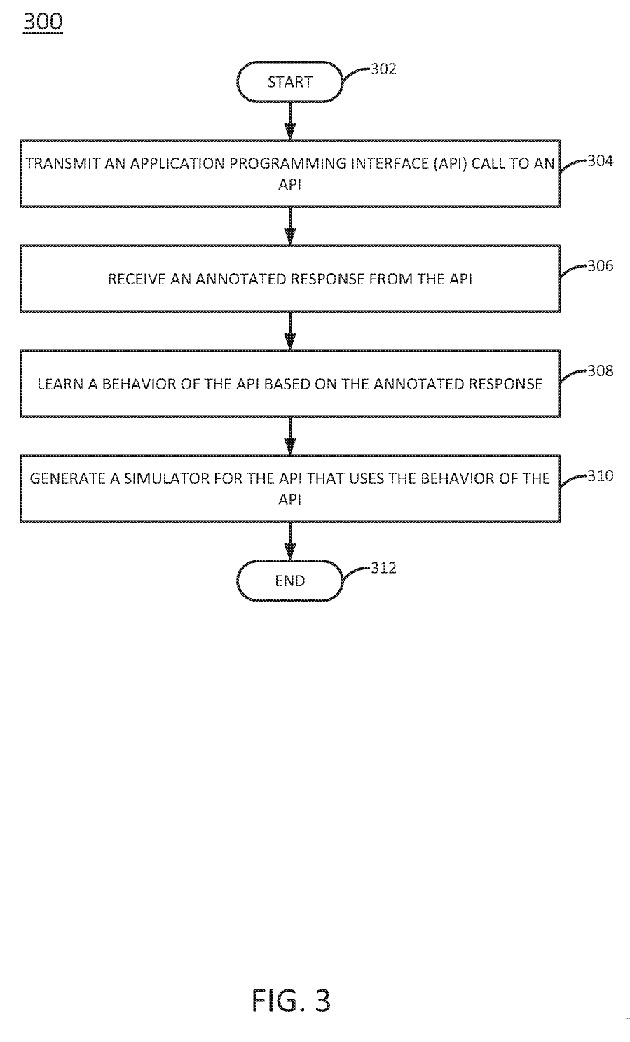

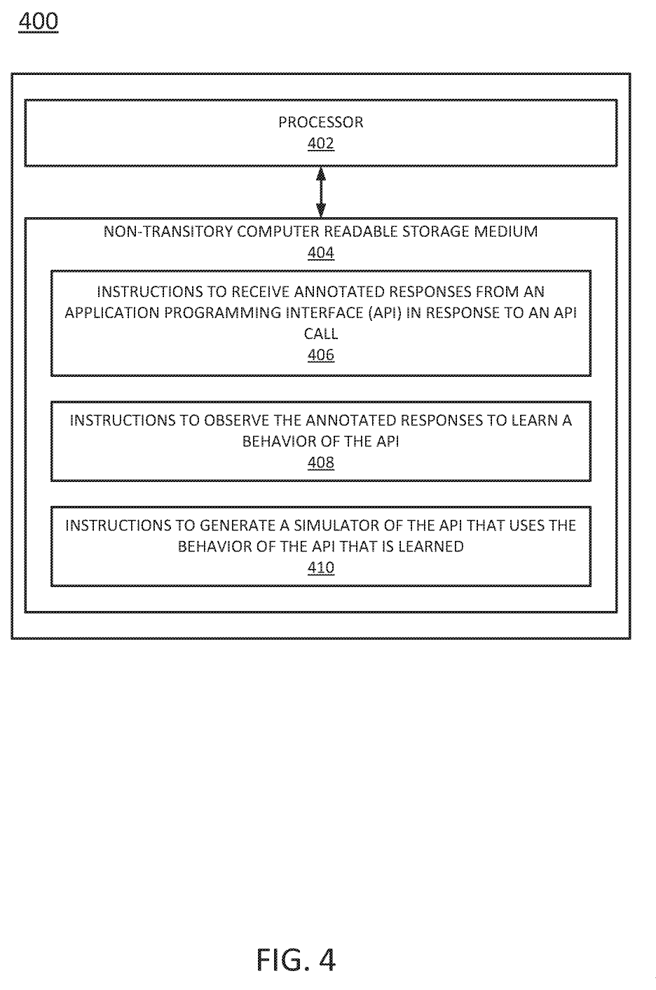

FIG. 3 illustrates a flow diagram of an example method 300 for generating an API simulator based on an API behavior that is learned based on annotated responses observed during an API simulation. In an example, the method 300 may be performed by the hardware device 102 or the apparatus 400 illustrated in FIG. 4 and described below.

At block 302, the method 300 begins. At block 304, the method 300 transmits an application programming interface (API) call to an API. In one example, a first instance of the interaction between the hardware device the API may be with an API hardware that includes a full implementation of the API. The hardware device may be a peripheral device (e.g., a router, a blade server, a rack server, a firewall, switch, and the like) of a datacenter center. The hardware device may establish a wired or wireless communication path to the hardware executing the simulator to transmit the API call.

At block 306, the method 300 receives an annotated response from the API. The annotated response may be annotated in advance. In other words, the responses may be annotated before the hardware device begins interaction with a simulator. The annotated response may be received over the wired or wireless communication path described above.

At block 308, the method 300 learns a behavior of the API based on the annotated response. For example, the transmitting of the API call and the reception of the annotated responses may be repeated until the behavior is learned. The behavior may be learned when a pre-defined number of annotated responses are repeated. For example, when a large number of annotated responses are repeated the behavior may be assumed to be learned.

In another example, the behavior may be learned when all of the annotated responses are observed. For example, the simulator may know all of the responses for the API. The simulator may track when all of the responses have been sent. When all of the responses have been sent, the simulator may send a notification to the hardware device. The hardware device may determine that the behavior has been learned based on the notification.

At block 310, the method 300 generates a simulator for the API that uses the behavior of the API. After the behavior has been learned, the simulator may be generated. The simulator may be replicated via software to eliminate the need for the hardware to execute the simulator for the API.

As a result, any number of other hardware devices may simulate interaction with the API by interacting with the simulator generated by the hardware device and observing the annotated responses rather than having each hardware device interact with different instances of expensive hardware that has a full implementation of the API. For example a second hardware device may be communicatively coupled to the hardware device with the simulator of the API. The second hardware device may then simulate interaction with the API using the simulator on the hardware device rather than having to purchase an expensive API hardware that has the full API implementation.

In addition, the simulator may be automatically updated when the API on the API hardware changes. For example, a user or technician may learn that the API has been updated or modified. The hardware device may be reconnected to the API hardware and the blocks of method 300 may be repeated to learn the changes or updates to the API automatically. At block 312, the method 300 ends.

FIG. 4 illustrates an example of an apparatus 400. In an example, the apparatus 400 may be the hardware device 102 illustrated in FIG. 1. In an example, the apparatus 400 may include a processor 402 and a non-transitory computer readable storage medium 404. The non-transitory computer readable storage medium 404 may include instructions 406, 408, and 410 that, when executed by the processor 402, cause the processor 402 to perform various functions.

In an example, the instructions 406 may include instructions to receive annotated responses from an application programming interface (API) in response to an API call. The instructions 408 may include instructions to observe the annotated responses to learn a behavior of the API. The instructions 410 may include instructions to generate a simulator of the API that uses the behavior of the API that is learned.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a communication interface to communicate with an application programming interface (API) via annotated responses;
a processor in communication with the communication interface to receive the annotated responses; and
a learning device in communication with the processor to analyze the annotated responses, learn a behavior of the API, and generate a simulator for the API.

2. The apparatus of claim 1, wherein the annotated responses are received in response to an API call.

3. The apparatus of claim 1, wherein the annotated responses comprise a document in a particular format.

4. The apparatus of claim 1, wherein the annotated responses comprise an identification of a dynamic field.

5. The apparatus of claim 4, wherein the dynamic field describes how to synthesize a value for the dynamic field for a particular response.

6. The apparatus of claim 5, wherein the identification comprises a name of a field, a type of data in the dynamic field, and a random data generator.

7. The apparatus of claim 1, wherein the annotated response comprises an identification of a static field.

8. The apparatus of claim 1, wherein the annotated response comprises an identification of a keystone field.

9. The apparatus of claim 1, wherein the keystone field describes certain fields to include in a response when the keystone field is included.

10. A method, comprising:
transmitting, by a processor, an application programming interface (API) call to an API;
receiving, by the processor, an annotated response from the API;
learning, by the processor, a behavior of the API based on the annotated response; and
generating, by the processor, a simulator for the API that uses the behavior of the API.

11. The method of claim 10, wherein the transmitting and the receiving are repeated until the behavior of the API is learned.

12. The method of claim 10, wherein the behavior of the API is learned when a pre-defined number of annotated responses are repeated.

13. The method of claim 10, wherein the API is executed on a peripheral device of a datacenter server.

14. The method of claim 10, further comprising:
repeating, by the processor, the transmitting, the receiving, the learning, and the generating when the API changes.

15. The method of claim 10, wherein the annotated response is annotated before the API communicates with the processor.

16. A non-transitory computer readable storage medium encoded with instructions executable by a processor, the non-transitory computer-readable storage medium comprising:
instructions to receive annotated responses from an application programming interface (API) in response to an API call;
instructions to observe the annotated responses to learn a behavior of the API; and
instructions to generate a simulator of the API that uses the behavior of the APU that is learned.

17. The non-transitory computer readable storage medium of claim 16, wherein the annotated responses comprise an identification of a dynamic field.

18. The non-transitory computer readable storage medium of claim 17, wherein the dynamic field describes how to synthesize a value for the dynamic field for a particular response.

19. The non-transitory computer readable storage medium of claim 18, wherein the identification comprises a name of a field, a type of data in the dynamic field, and a random data generator.

20. The non-transitory computer readable storage medium of claim 16, wherein the annotated response comprises an identification of a keystone field that describes certain fields to include in a response when the keystone field is included.
